(19) United States
(12) Patent Application Publication
(10) Pub. No.: US 2018/0015580 A1
(43) Pub. Date: Jan. 18, 2018

(54) ADJUSTABLE PIN CLAMPING DEVICE

(71) Applicant: Tech Rim Standards, LLC, Auburn Hills, MI (US)

(72) Inventors: Marek Bieciuk, Shelby Township, MI (US); Michael John Vanston, Rochester Hills, MI (US)

(21) Appl. No.: 15/211,733

(22) Filed: Jul. 15, 2016

(51) Int. Cl. B23Q 3/06; B25B 5/16

(52) U.S. Cl. CPC B23Q 3/069; B25B 5/16

(57) ABSTRACT

A number of variations may include a pin clamping device having a clamp hook connected to an actuator constructed and arranged to apply at least a downward force to the clamp hook and a biasing system constructed and arranged to apply an upward force to the clamp hook while a downward force is being applied to the clamp hook by the actuator.

### TECHNICAL FIELD

The field to which the disclosure generally relates to includes pin clamping devices and methods of making and using the same.

### BACKGROUND

A pin clamping device may be used to locate and clamp a workpiece.

### SUMMARY OF ILLUSTRATIVE VARIATIONS

A number of variations may include a pin clamping device having a clamp hook connected to an actuator constructed and arranged to apply at least a downward force to the clamp hook and a biasing system constructed and arranged to apply an upward force to the clamp hook while a downward force is being applied to the clamp hook by the actuator.

A number of variations may include a pin clamping device having a location pin constructed and arranged to move as the clamping device clamps onto a workpiece.

A number of variations may include an adjustable pin clamping device comprising a location pin constructed and arranged to slidably move in a through-hole of a base constructed and arranged to support a workpiece.

A number of variations may include an adjustable pin clamping device including a location pin having a shaft extending through a through-hole in a base, the base having a platform constructed and arranged to support a workpiece, and wherein the location pin is biased upward.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a perspective view of an adjustable pin clamping device according to a number of variations.

FIG. 2 is a sectional view of a pin clamping device according to a number of variations.

FIG. 3 is a partial view, with a portion partially sectioned of a pin clamping device according to a number of variations.

FIG. 4 is a partial view, with a portion partially sectioned of a pin clamping device according to a number of variations.

### DETAILED DESCRIPTION OF ILLUSTRATIVE VARIATIONS

The following description of the variations is merely illustrative in nature and is in no way intended to limit the scope of the invention, its application, or uses.

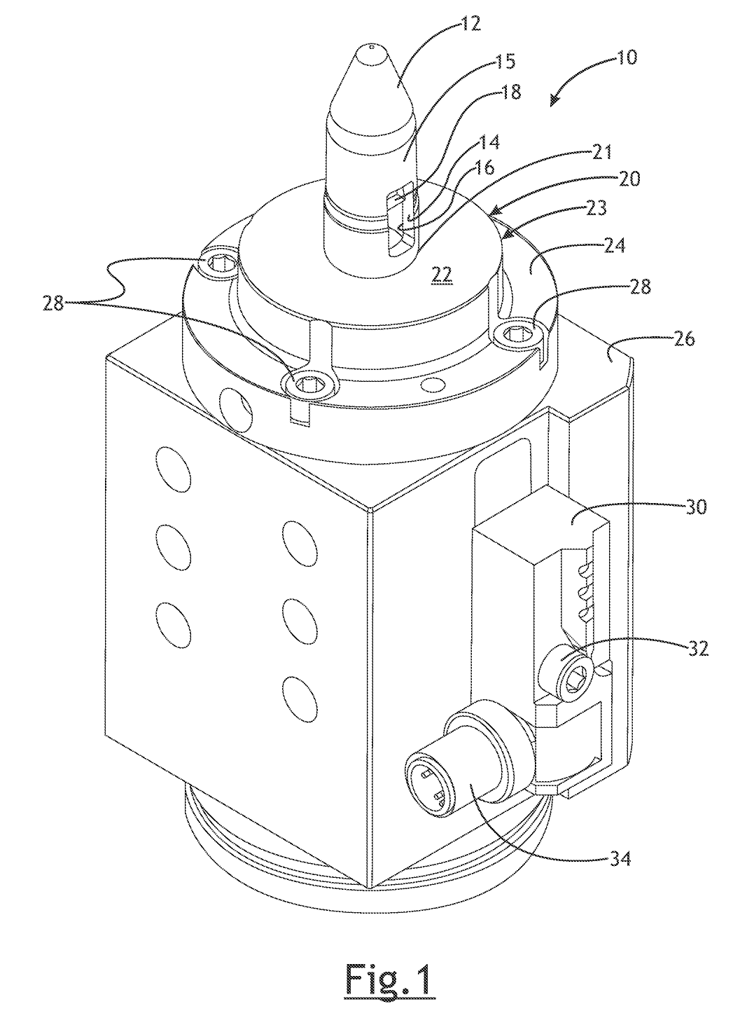

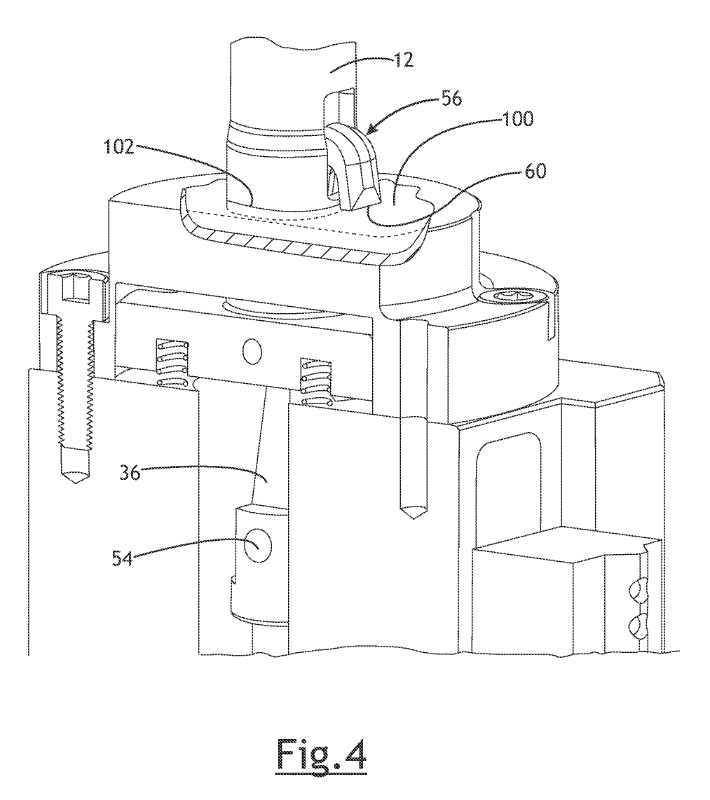

FIGS. 1-4 illustrate a number of variations which may include an adjustable pin clamping device 10. The adjustable pin clamping device 10 may include a location pin 12 having a window 14 formed in an outer wall 15. An elongated cavity 16 may be provided in the pin 12. A clamping hook 18 may be received in the elongated cavity 16 in the location pin 12. A base 20 may be provided and may have a through-hole 21 formed therein through which a portion of the location pin 12 extends. The base 20 may include a platform 22 constructed and arranged to support a workpiece. The workpiece 100 (shown in FIG. 4) may have a through-hole formed 102 therein. The workpiece 100 may be placed so that the through-hole 102 formed in the workpiece receives the location pin 12 of the adjustable pin clamping device 10 to properly locate the workpiece on the device 10. The base 20 may include a first portion 23 having a through-hole 21 formed therein. In a number of variations, the first portion 23 may have a disc shape. The base 20 may also have a collar positioned below the first portion 23 and wherein the collar 24 extends radially outward from the first portion 23. A plurality of fasteners 28 may be provided to connect the collar 24 to a body 26 of the adjustable pin clamping device 10. A sensor 30 may be attached to the body 26 by a fastener 32. An electrical connection 34 may be provided to allow electrical communication between the sensor 30 and an electronic control device (not shown).

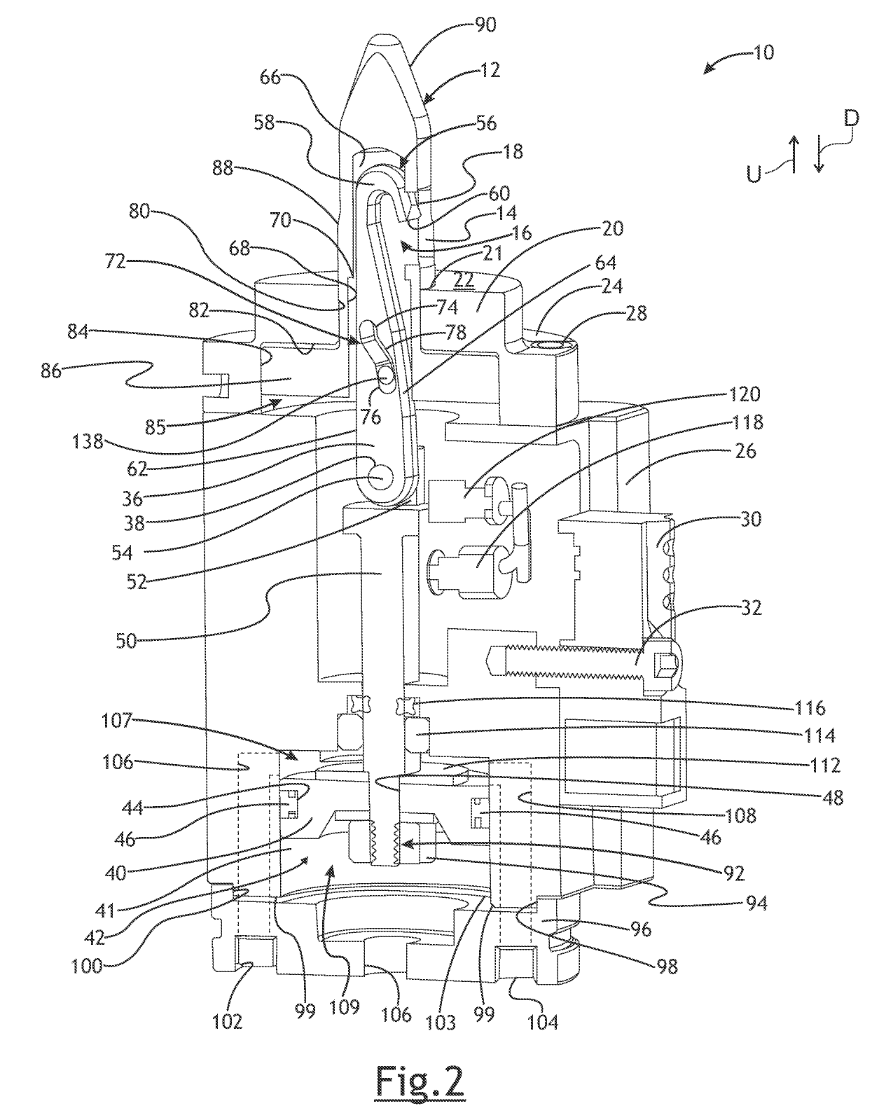

Referring now to FIG. 2, in a number of variations an adjustable pin clamping device 10 may be constructed and arranged so that the clamping hook 18 includes a shaft 36 having a through-hole 38 formed therein so that the clamping hook 18 may be operatively connected to a piston 40 received in a piston chamber 42 formed in the body 26. The piston 40 may include a circumferential groove 42 formed therein and a piston seal 46 may be received in the circumferential groove 42 to seal against the surface 41 of the body 26 defining the piston chamber 42. The piston 40 may include a through-hole 48 formed therein through which a portion of a piston rod 50 extends. A finger projection 52 may be provided at an end of the piston rod 50 and a pivot pin 54 may extend from the finger projection 52 and into the through-hole 38 formed in the shaft 36 of the clamping hook 18. In a number of variations the clamping hook 18 may have a curved hook portion 56 connected to the shaft 36. A hook tip 60 may be provided at the end of the curved hook portion 56 and constructed and arranged to engage and clamp down on a workpiece positioned on the platform 22 of the base 20. The clamping hook 18 may include a first side edge 62 and an opposite second side edge 64. In a number of variations, the first side edge 62 may be relatively straight and the second side edge 64 may converge toward the first side edge 62 or may be curved toward the first side edge 62. The elongated cavity 16 formed in the location pin 12 may include a first upper cylindrical portion 66 and a second lower cylindrical portion 68 separated by a step 70, wherein the second lower cylindrical portion 68 has a diameter greater than the first cylindrical portion 66. A slot 72 may be formed in the clamping hook 18 at a location between the through-hole 38 and the curved hook portion 56. In a number of variations, the slot 72 may include a first upper portion 74 and an opposite lower second portion 76. The first upper portion 74 of the slot 72 may run in a direction generally parallel to the first side edge 62 of the hook and/or parallel to an axis of the piston rod 50. Similarly, the second lower portion 76 of the slot 72 may run in a direction generally parallel to the first side edge 62 of the clamping hook 18 or the axis of the piston rod 50, but spaced a distance further away from the first side edge 62 of the clamping hook than the first upper portion 74. A third section 78 of the slot 72 may communicate with the first upper section 74 and the second lower section 76 and may be formed at an angle with respect to the first side edge 62 of the clamping hook or an axis of the piston rod 50. In a number of variations, the slot 72 may have a lazy S configuration.

The through-hole 21 in the first portion 23 of the base 20 may be defined by an inner cylindrical wall 80 which is connected to a radially outward extending step 82 that connects to a second cylindrical wall 84 formed in the collar portion 24. The location pin 12 may include a flange portion 86 that may extend radially outward so that at least a portion of the flange portion 84 is received in a collar cavity 85 which may be defined at least in part by the second cylindrical wall 84 and the radially outward extending step 82. The location pin 12 may include a shaft 88 connecting the flange portion 86 to a cone-shaped tip 90. The shaft 88 of the location pin 12 may slidably move in the through-hole 21 formed in the first portion 23 of the base 20.

In a number of variations, a lower end of the piston rod 50 may be threaded 92 and a nut 94 may be secured to the threaded end on one side of the piston 40. On the other side of the piston 40, a washer 112 may be positioned on the piston 40 and receive the piston rod 50. A guide bushing 114 may be provided and secured in the body 26 and a seal 116 provided above the guide bushing with the piston rod 50 extending through each.

A cap 96 may be provided and secured to the body 26. In a number of variations, the body 26 may include a neck 98 which may be threaded from mating with a threaded throat portion 100 of the cap 96. A gasket 101 may be provided at the end 99 of the neck 98 of the body 26 and may engage a gasket seat 103 provided in the cap 96. In a number of variations, the cap 96 may have a first air port 102 formed therein which communicates with a first channel 106 formed in the body and communicating with an upper portion 107 of the piston chamber 42 which is above the piston 40. Optionally, a second air port 104 may be provided in the cap 96 and communicate with a second air channel 108 formed in the body which also communicates with the upper portion 107 of the piston chamber 42. A third air port 106 may be provided in the cap and constructed and arranged to communicate with a lower portion 109 of the piston chamber 42 which is below the piston 40. In a number of variations, the air ports 102, 104 and 106 may be connected to air lines which may each have a valve therein to control the flow of air to be provided into the piston chamber 42 through air port 106 to move the piston 40 upward and thereby move the clamping hook 18 in an upward direction. Similarly, air may be provided through one of the air ports 102 or 104 to provide air above the piston and push the piston in a downward direction, causing the clamping hook 18 to also move in a downward direction.

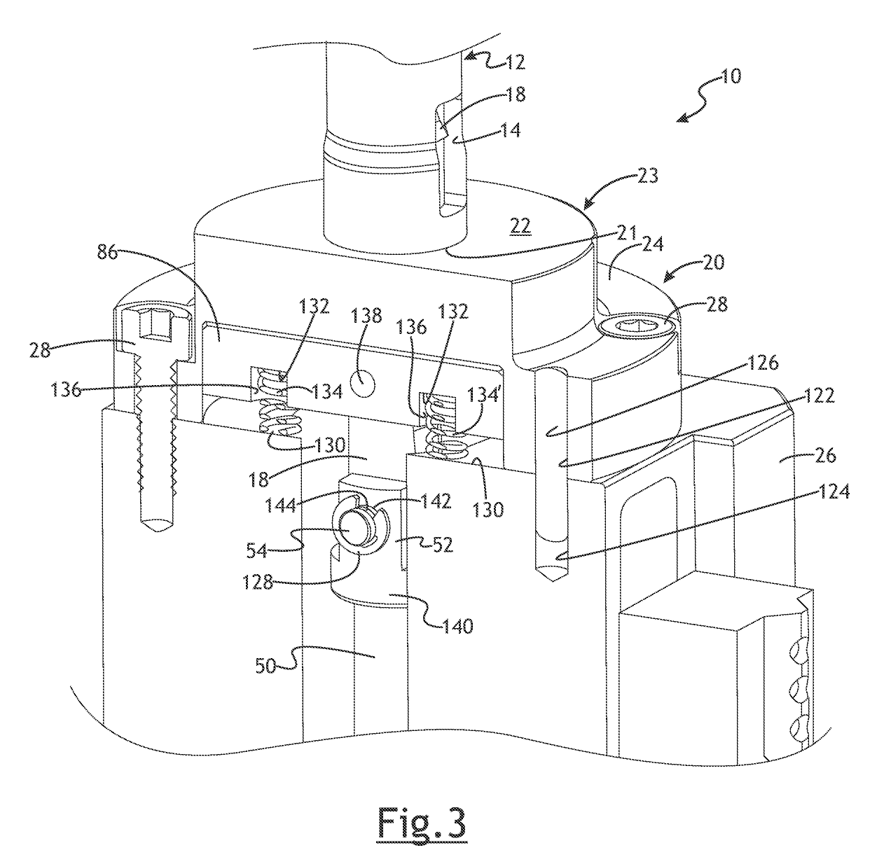

Referring now to FIG. 3, in a number of variations, the flange portion 86 of the location pin 12 may include a first cavity 136 formed therein which may receive a portion of a spring 34 that engages a surface 132 defining a portion of the cavity 136. A first end of the spring 132 may rest on a first engagement surface 130 provided by the body 26. A second end of the spring 134 may engage a second spring engagement surface 132 which defines a portion of the cavity 136 in the flange portion 86. One or more springs 134 and cavities 136 may be provided to bias the location pin 12 in an upward direction (direct of arrow U) toward the cone-shaped tip 90. The biasing of the location pin 12 in an upward direction allows the pin clamping device to be used with a variety of workpieces of different thicknesses while still allowing the hook tip 60 to firmly clamp down on the workpiece and may be constructed and arranged to prevent denting of the workpiece by the clamp tip 60. In a number of variations, the springs 34 may be constructed and arranged to accommodate and adjust for changes in the thickness of workpieces ranging up to 4 mm. In a number of variations, the springs 34 may be selected to provide an upward biasing force on the pin locator 12 (or clamping hook 18) ranging from 105-62 foot pounds. In a number of variations, the air pressure supplied to move the piston in a downward direction may be such as to overcome the upward biasing force of the springs on the pin locator 12.

Referring again to FIGS. 2-3, a guide pin 138 may extend from location pin 12, for example from the flange portion 86 of the location pin 12, and into the through-slot 72 to guide movement of the clamping hook 18. In a number of variations, the slot 72 may be configured so that when the piston rod 50 is in a fully upward extended position the guide pin 138 engages a lowermost contact surface 6 at the lower end of the slot 72 in the second lower section 76 and the hook portion 56 of the clamping hook 18 is received in the cavity 16 near the upper end of the first cylindrical portion 66 of the cavity 16. As the piston 40 travels in a downward direction (in the direction of arrow D toward the cap 96) the guide pin 138 and the second lower section 76 of the slot 72 causes the hook portion 56 to move downward in the first portion 66 of the cavity 16, and as the piston 40 travels further in a downward direction the guide pin 138 enters the third section 78 of the slot 72 causing the hook portion 56 to extend out the window 14 of the location pin 12. During further downward movement of the piston 40 the guide pin 138 engages an upper most contact surface 8 at an upper end of the first upper section 74 of the slot 72 and further downward movement of the piston 40 causes the location pin 12 to move downward against the upward biasing force of the springs 34. Further downward movement of the piston 40 causes the hook tip 60 to engage and clamp on a workpiece positioned on the platform 22 of the body 20.

In a number of variation, an adjustable pin clamping device 10 may be constructed and arranged so that there is an upward biasing force on the location pin 12 or clamping hook 18 by any of a pneumatic, hydraulic, mechanical, electromechanical components which may apply the upward biasing force directly to the clamping hook 18 or indirectly, for example through the location pin 12. In a number of variations the claiming hook 18 may be moved upward and downward by any of a variety of components including, but not limited to, a pneumatic, hydraulic, mechanical, electromechanical components. For example, but not limited to, a steeper motor or magnetic coil device may be used to move the clamping hook 18 upward or downward. As described above at some point during the downward movement of the claiming hook 18 the downward movement is made against the upward biasing force applied directly or indirectly to the clamping hook 18 so that workpieces of varying thicknesses can be clamped down on the base 20.

In a number of variations, a threaded connector 140 may be secured to a threaded end of the piston rod 50 (FIG. 3). The threaded connector 140 may include the flange 52 which may have a through-hole 142 formed therein through which the guide pin 54 extends and is secured thereto by a C clasp 128 received in a groove 144 formed in the guide pin 54. A first dowel pin cavity 22 may be formed in the base 20 and aligned with a second dowel pin 124 formed in the body 26. A dowel pin 126 may be received in the cavities 122, 124 to align the base 26 with the spring 130 received in a cavity 136 of the flange portion 86 of the location pin 12. The plurality of fasteners 28 may be used to secure the base 20 to the body 26 in a fashion that allows the springs 134 to provide the appropriate upward biasing force on the location pin 12.

Referring again to FIG. 2, a first sensor target 118 and a second sensor target 120 may be provided in position to determine the open and closed position of the clamping hook 18 using the sensor 30.

A number of variations may include a method of clamping a workpiece including providing an adjustable pin clamping device and a workpiece to be clamped in position by the adjustable pin claiming device, wherein the adjustable pin clamping device includes a clamp hook received in a location pin, the locating pin having a window formed in a wall thereof and wherein the clamp hook may be constructed and arranged to extend out the window. The method may include placing a first workpiece on the location pin and applying a first force to move the clamp hook in an upward direction, applying a second force to the clamp hook to extend the clamp hook out of the window in the location pin and in a downward direction toward the first workpiece and applying a third force to the clamp hook in an upward direction while the second force is being applied to the clamp hook, wherein the second force is greater than the third force so that the second force causes the clamp hook to clamp the first workpiece, which may occur without denting the first workpiece. The method may also include thereafter applying the first force to move the clamp hook in an upward direction, removing the first workpiece from the adjustable pin clamping device, and placing a second work piece on the location pin, applying the second force to the clamp hook to extend the clamp hook out of the window in the location pin and in a downward direction toward the second workpiece and applying a third force to the clamp hook in an upward direction while the second force is being applied to the clamp hook, wherein the second force is greater than the third force so that the second force causes the clamp hook to clamp the second workpiece, which may occur without denting the second workpiece, and wherein the first workpiece and second workpiece have different thicknesses where they are clamped by the clamp hook. In a number of variations the method may include applying the third force to the clamp hook directly. In a number of variations the method may include applying the third force to the clamp hook indirectly through the location pin. In a number of variations the method may include applying the third force to the clamp hook indirectly through the location pin mechanically connected to the clamp hook. In a number of variations the method may include applying the third force to the clamp hook indirectly through the location pin mechanically connected to the clamp hook by a guide pin extending from the location pin and received in a slot formed in the clamp hook. In a number of variations the adjustable pin clamping device may include at least one spring constructed and arranged to apply the third force to the clamp hook. In a number of variations the at least one spring is constructed and arranged so that the guide pin engages the clamp hook at the upper end of the slot to apply an upward force to the clamp hook.

The above description of select variations within the scope of the invention is merely illustrative in nature and, thus, variations or variants thereof are not to be regarded as a departure from the spirit and scope of the invention.

What is claimed is:

1. An adjustable pin clamping device comprising:
a clamp hook received in a location pin, the locating pin having a window formed in a wall thereof;
the clamp hook being constructed and arranged to be moveable in an upward direction when a first force is applied thereto, and the clamp hook being constructed and arranged to extend out a window in a wall of the location pin and in a downward direction when a second force is applied the clamp hook;
a biasing system constructed and arranged to apply a third force in an upward direction to the clamp hook while the second force is being applied to the clamp hook, wherein the second force is greater than the third force so that the second force causes the clamp hook to clamp the first workpiece.

2. An adjustable pin clamping device as set forth in claim 1 wherein clamping pin is constructed and arrange to clamp on workpiece of different thicknesses where the clamp hook clamps the workpiece.

3. An adjustable pin clamping device as set forth in claim 1 wherein the biasing system is constructed and arranged to apply the third force directly to the clamp hook

4. An adjustable pin clamping device as set forth in claim 1 wherein the biasing system is constructed and arranged to apply indirectly through the location pin.

5. An adjustable pin clamping device as set forth in claim 4 wherein the location pin is mechanically connected to the clamp hook.

6. An adjustable pin clamping device as set forth in claim 4 wherein the location pin is mechanically connected to the clamp hook by a guide pin extending from the location pin and received in a slot formed in the clamp hook.

7. An adjustable pin clamping device as set forth in claim 1 wherein the biasing system comprises at least one spring constructed and arranged to apply the third force to the clamp hook.

8. An adjustable pin clamping device as set forth in claim 6 wherein the at least one spring is constructed and arranged so that the guide pin engages the clamp hook at the upper end of the slot to apply an upward force to the clamp hook.

9. An adjustable pin clamping device comprising:
a location pin having a window formed in an outer wall and an elongated cavity provided in the pin,
a clamping hook received in the elongated cavity in the location pin,
a base provided and having a through-hole formed therein through which a portion of the location pin extends, and wherein the base includes a platform constructed and arranged to support a workpiece, the base being connected to a body,
an actuator connected to the clamp hook to move the clamp hook in an upward direction, and to extend the clamp hook out of the window formed in a wall of the location pin and in a downward direction toward the portion of the base constructed and arranged to support a workpiece,
and a biasing system constructed and arranged to apply a force in an upward direction to the clamp hook while the actuator moves the clamp hook in a downward direction toward the portion of the base constructed and arranged to support a workpiece so that the adjustable pin clamping device can clamp workpieces of different thicknesses where the clamp hook claims the workpiece.

10. An adjustable pin clamping device as set forth in claim 9 wherein the actuator comprises a piston received in the body.

11. An adjustable pin clamping device as set forth in claim 10 wherein the piston a pneumatic piston.

12. An adjustable pin clamping device as set forth in claim 9 wherein the actuator comprises a piston having a piston rod connected thereto and to the clamp hook.

13. An adjustable pin clamping device as set forth in claim 9 wherein the biasing system is constructed and arranged to apply a force in an upward direction to the clamp hook through the location pin.

14. An adjustable pin clamping device as set forth in claim 9 wherein the biasing system comprises at least one spring supported by the body and biasing the location pin in an upward direction.

15. An adjustable pin clamping device as set forth in claim 9 wherein the location pin is mechanically connected to the clamp hook by a guide pin extending from the location pin and received in a slot formed in the clamp hook.

16. A method of clamping a workpiece comprising:
providing an adjustable pin clamping device and a workpiece to be clamped in position by the adjustable pin claiming device, wherein the adjustable pin clamping device includes a clamp hook received in a location pin, the locating pin having a window formed in a wall thereof and wherein the clamp hook being constructed and arranged to extend out the window,
placing a first workpiece on the location pin and applying a first force to move the clamp hook in an upward direction,
applying a second force to the clamp hook to extend the clamp hook out of the window in the location pin and in a downward direction toward the first workpiece,
and applying a third force to the clamp hook in an upward direction while the second force is being applied to the clamp hook, wherein the second force is greater than the third force so that the second force causes the clamp hook to clamp the first workpiece.

17. The method as set forth in claim 16 further comprising thereafter applying the first force to move the clamp hook in an upward direction, removing the first workpiece from the adjustable pin clamping device, and placing a second work piece on the location pin, applying the second force to the clamp hook to extend the clamp hook out of the window in the location pin and in a downward direction toward the second workpiece and applying a third force to the clamp hook in an upward direction while the second force is being applied to the clamp hook, wherein the second force is greater than the third force so that the second force causes the clamp hook to clamp the second workpiece, and wherein the first workpiece and second workpiece have different thicknesses where they are clamped by the clamp hook.

18. A method as set forth in claim 16 wherein applying the third force to the clamp hook comprises directly applying the third force to the clamp hook.

19. A method as set forth in claim 16 wherein applying the third force to the clamp hook comprises applying the third force indirectly to the clamp hook through the location pin.

20. A method as set forth in claim 19 wherein the location pin mechanically is connected to the clamp hook.

21. A pin clamping device having a clamp hook connected to an actuator constructed and arranged to apply at least a downward force to the clamp hook and a biasing system constructed and arranged to apply an upward force to the clamp hook while a downward force is being applied to the clamp hook by the actuator.

22. A pin clamping device having a location pin constructed and arranged to move as the clamping device clamps onto a workpiece.

23. An adjustable pin clamping device comprising a location pin constructed and arranged to slidably move in a through-hole of a base constructed and arranged to support a workpiece.

24. An adjustable pin clamping device including a location pin having a shaft extending through a through-hole in a base, the base having a platform constructed and arranged to support a workpiece, and wherein the location pin is biased upward.
